(19) United States
(12) Patent Application Publication
(10) Pub. No.: US 2025/0343818 A1
(43) Pub. Date: Nov. 6, 2025

(54) System and Method for Automated Penetration Testing and Security Assessment

(71) Applicant: Cameron Immesoete, Orinda, CA (US)

(72) Inventor: Cameron Immesoete, Orinda, CA (US)

(21) Appl. No.: 18/655,473

(22) Filed: May 6, 2024

(51) Int. Cl. H04L 9/40

(52) U.S. Cl. CPC H04L 63/1483; H04L 63/1433

(57) ABSTRACT

A system for automated penetration testing using artificial intelligence (AI) is described, which aims to enhance cybersecurity by simulating attacks on software and computer systems in order to measure and identify vulnerability. The platform employs AI agents to perform tasks including script execution for vulnerability testing, social engineering simulations, comprehensive security assessments, and more, thereby reducing costs, time, potential risks associated with traditional penetration testing methods, and providing a more complete and available solution than humans can produce alone.

### TECHNICAL FIELD

The disclosed embodiments relate generally to cybersecurity and specifically to systems and methods for automated penetration testing using artificial intelligence to identify vulnerabilities in software and computer systems.

### BACKGROUND

Traditional penetration testing methods are labor-intensive, costly, perhaps limited by time of day, and can inadvertently introduce new vulnerabilities. There is a growing need for more efficient, continuous, and automated approaches to security testing, especially with the increasing complexity and scale of IT environments.

### SUMMARY

The invention provides a computer-implemented method for automated penetration testing using AI. The system creates a mirrored environment of the target system where AI agents are deployed to conduct a variety of security tests. These agents simulate both external attacks and internal breaches, providing a comprehensive assessment of system vulnerabilities and potential human factor exploits.

### BRIEF DESCRIPTION OF THE DRAWINGS

FIG. 1 illustrates a system architecture diagram showing the main components of the automated penetration testing platform and their interactions, including the deployment of AI agents and the data flow between the mirrored environment and the analysis tools.

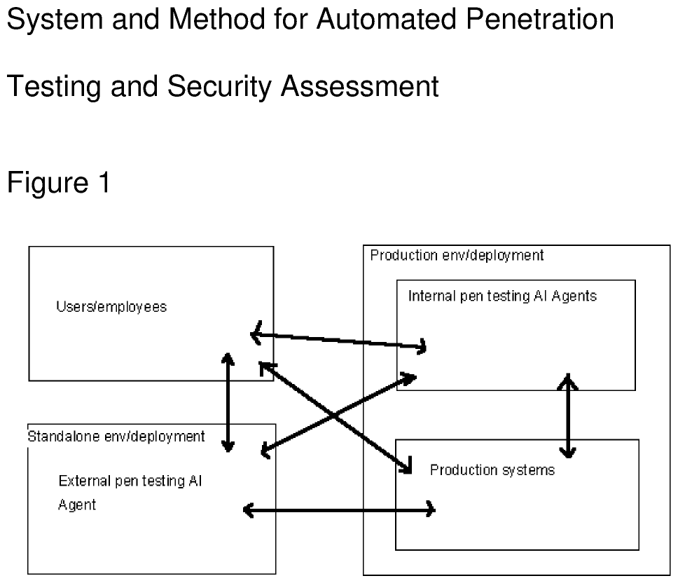

### System and Method for Automated Penetration

[symbol]

### Testing and Security Assessment

[symbol]

1. A computer-implemented method for automated penetration testing in an organization, comprising:
a. Deploying multiple AI agents in a mirrored environment of the target system to simulate various types of cyber attacks and security breaches.
b. Utilizing AI to run scripts that test for vulnerabilities in software and systems, including but not limited to buffer overflows, SQL injections, and cross-site scripting.
c. Simulating social engineering attacks to assess the susceptibility of organizational personnel to phishing, pretexting, and other forms of manipulation both internally and externally.

2. The method of claim 1, wherein the AI agents are configured to:
a. Perform continuous security assessments to adapt to new threats dynamically as they are identified in the cybersecurity landscape.
b. Generate reports detailing vulnerabilities, the potential impact of breaches, and recommended mitigation strategies.

3. The method of claim 1, further comprising:
a. An interface for security administrators to view real-time analytics of the testing process and intervene or adjust parameters as necessary.
b. Integration with existing security tools and infrastructure to provide a holistic view of organizational security posture.

4. The method of claim 1, wherein the penetration testing includes:
a. Testing network security by attempting to breach firewalls, routers, and switches using known vulnerabilities and zero-day exploits.
b. Assessing the strength of current security policies and practices within the organization and suggesting enhancements based on testing outcomes.

5. The method of claim 1, wherein the AI agents use machine learning models to:
a. Learn from each testing cycle to improve the efficiency and effectiveness of subsequent simulations.
b. Detect patterns that may indicate complex attack vectors that combine multiple lower-risk vulnerabilities into a significant threat.
